(19) United States
(12) Patent Application Publication
(10) Pub. No.: US 2018/0370348 A1
(43) Pub. Date: Dec. 27, 2018

(54) COOLING DEVICE

(71) Applicant: DENSO CORPORATION, Kariya-city, Aichi-pref. (JP)

(72) Inventors: Yasuhiro TAKEUCHI, Nishio-city (JP); Haruo KAMIYA, Nishio-city (JP); Kenji YOSHIDA, Kariya-city (JP); Takahiro IWASAKI, Kariya-city (JP)

(21) Appl. No.: 15/781,803

(22) PCT Filed: Sep. 9, 2016
(86) PCT No.: PCT/JP2016/076615

§ 371 Date: Jun. 6, 2018

(30) Foreign Application Priority Data
Dec. 9, 2015 (JP) 2015-240495

(51) Int. Cl. B60K 11/08; B60K 11/06; B60K 11/04; F01P 3/18; F01P 5/06

(52) U.S. Cl. CPC B60K 11/08; B60K 11/06; F01P 5/06; F01P 3/18; B60K 11/04

(57) ABSTRACT

A cooling device includes: a pump arranged to supply air at a position separated from a space where a wind flows; and a front grille arranged in an introduction port where the wind is introduced. The front grille is located at a position opposing a radiator, and includes at least one support component having a hollow shape in which air is able to flow. A discharge part of the pump is connected to the support component such that air discharged from the discharge part flows into an interior space of the support component. The support component has an air blow-out part at a position opposing the radiator to blow out air which flows inside of the support component.

### CROSS REFERENCE TO RELATED APPLICATION

This application is based on Japanese Patent Application No. 2015-240495 filed on Dec. 9, 2015, the disclosure of which is incorporated herein by reference.

### TECHNICAL FIELD

The present disclosure relates to a cooling device for a vehicle in which a radiator is disposed at a position where a wind generated when the vehicle is driven is introduced to exchange heat between the wind and a fluid to be cooled.

### BACKGROUND ART

Conventionally, an engine cooling device is known, in which a radiator is arranged at a point where a wind is introduced when a vehicle is driven, and an engine is arranged behind the radiator (for example, refer to Patent Literature 1). Patent Literature 1 discloses a vaneless fan that sends air from the front side of the radiator to the engine, in order to restrict the air resistance mainly while the vehicle is travelling with high speed. The fan is located between the radiator and the engine or at the front side of the radiator.

### PRIOR ART LITERATURES

### Patent Literature

Patent Literature 1: JP 2012-67721 A

### SUMMARY OF INVENTION

According to the inventors' investigation, the fan disclosed by Patent Literature 1 has an annular shape surrounding the perimeter of the radiator. For example when the vehicle is travelling with low speed, the wind is not generated as expected. In such a situation, air will hardly flow into the central portion of the radiator although air flows into the perimeter side of the radiator. As a result, a heat dissipation area effective in the radiator will become small.

Thus, in the engine cooling device of Patent Literature 1, although the air resistance can be reduced when the vehicle is travelling, the effective heat dissipation area of the radiator will become small depending on the drive state of the vehicle. Such an issue is not limited to the vehicle equipped with the radiator for radiating heat of the engine, and is generated also in a vehicle equipped with a radiator in which heat is exchanged between the wind and a fluid to be cooled.

It is an object of the present disclosure to provide a cooling device, in which an effective heat dissipation area is secured for a radiator exchanging heat between the wind and the fluid, and an air resistance can be reduced, when the vehicle is travelling.

According to an aspect of the present disclosure, the cooling device is applied to a vehicle in which a radiator is arranged to exchange heat between a wind and a fluid at a place where the wind is introduced when the vehicle is driven.

The cooling device includes: a pump arranged to supply air at a position separated from a space where the wind flows; and a front grille arranged in an introduction port where the wind is introduced. The front grille is located at a position opposing the radiator, and includes at least one support component having a hollow shape in which air is able to flow. A discharge part of the pump is connected to the support component such that air discharged from the discharge part flows into an interior space of the support component. The support component has an air blow-out part at a position opposing the radiator to blow out air from the inside of the support component.

Accordingly, an increase in the air resistance can be suppressed when the vehicle is driven, because the pump is located at the position separated from the space where the wind flows, and because the interior space of the support component of the front grille is used as a duct for flowing the air from the pump.

Furthermore, since air is blown out of the support component at the position opposing the radiator, a flowing area of the air in the radiator can be secured, compared with a case where air is blown off from a circumference of a radiator.

Therefore, the cooling device can be provided, in which an effective heat dissipation area is secured in the radiator, and the air resistance can be suppressed when the vehicle is driven.

### BRIEF DESCRIPTION OF DRAWINGS

FIG. 1 is a schematic view illustrating a cooling device according to a first embodiment.

FIG. 2 is a front view illustrating a front grille of the cooling device of the first embodiment.

FIG. 3 is a plan view illustrating the cooling device of the first embodiment.

FIG. 4 is a schematic view illustrating an air flow in the cooling device of the first embodiment.

FIG. 5 is a diagram for explaining a temperature distribution in a heat exchange part of a radiator.

FIG. 6 is a front view illustrating a front grille of a cooling device according to a second embodiment.

FIG. 7 is a cross-sectional view taken along a line VII-VII of FIG. 6.

FIG. 8 is a cross-sectional view taken along a line VIII-VIII of FIG. 6.

FIG. 9 is a plan view illustrating the cooling device of the second embodiment.

FIG. 10 is a schematic view illustrating a cooling device according to a third embodiment.

FIG. 11 is a schematic view illustrating an air flow in the cooling device of the third embodiment.

### DESCRIPTION OF EMBODIMENTS

Hereinafter, embodiments will be described according to the drawings. Same or equivalent portions among the embodiments below are labeled with same reference numerals in the drawings, and the explanation may be omitted.

Moreover, in the embodiments, when only a part of a component is explained, regarding the other part of the component, the component explained in the preceding embodiment can be applied.

The embodiments may be partially combined even if it is not explicitly described that the embodiments can be combined, provided there is no harm in the combination.

### First Embodiment

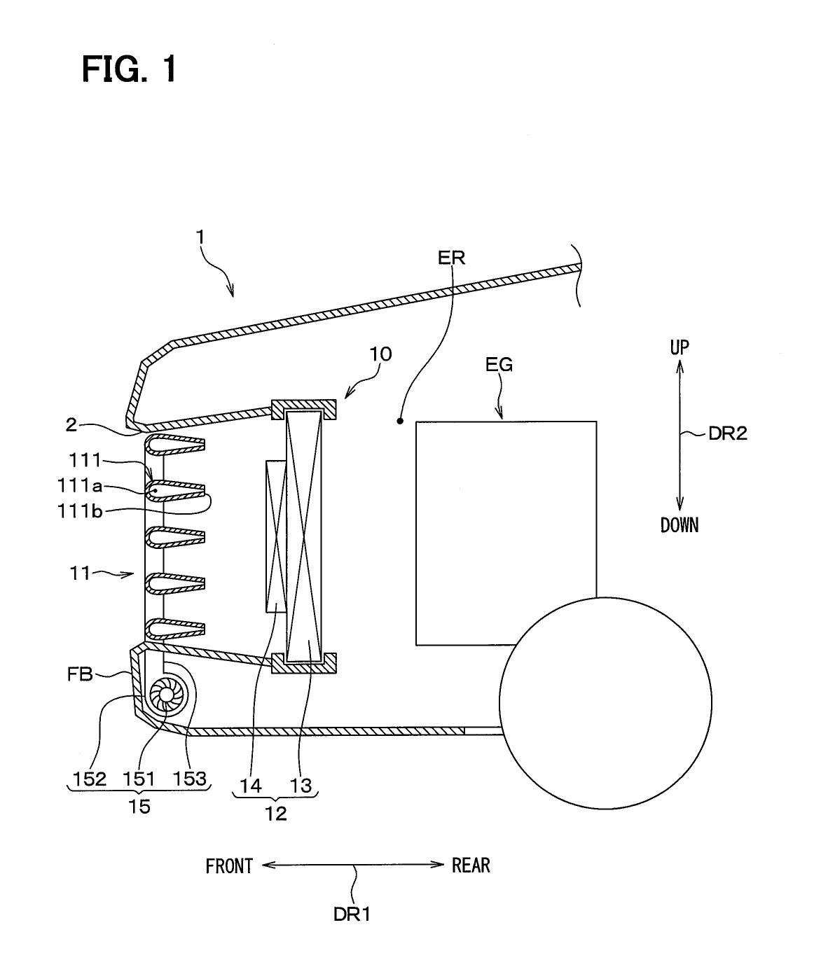

A first embodiment is described with reference to FIG. 1 to FIG. 4. An arrow DR1, an arrow DR2, and an arrow DR3, which are illustrated in the drawings, represent directions of a vehicle 1 in which a cooling device 10 is mounted. That is, in the drawings, the arrow DR1 represents a front and rear direction of the vehicle, the arrow DR2 represents an up and down direction of the vehicle, and the arrow DR3 represents a left and right direction of the vehicle.

The cooling device 10 is applied to a vehicle in which a radiator is arranged, for exchanging heat between a wind generated when the vehicle is driven and a fluid to be cooled, at a position where the wind is introduced. In this embodiment, the cooling device 10 is applied to the vehicle 1 in which the radiator 13 is arranged for radiating heat of the cooling water of the engine EG at the position where the wind is introduced when the vehicle is driven.

The vehicle 1, which is an automobile, has an engine room ER housing the engine EG that is a source of driving the vehicle, on the front side in the vehicle 1. An introduction port 2 is defined in the vehicle to introduce the wind into the engine room ER, and is located on the front side of the engine EG in the vehicle 1. The engine room ER corresponds to a portion into which the wind is introduced when the vehicle is driven, in this embodiment.

The front grille 11 is arranged in the introduction port 2. The front grille 11 is arranged to draw air into the engine room ER from the front side of the vehicle. The details of the front grille 11 are mentioned later.

A cooling module 12 is arranged between the front grille 11 and the engine EG, in the engine room ER. The cooling module 12 includes the radiator 13 and the condenser 14.

In the cooling module 12 of this embodiment, the condenser 14 is fixed to the radiator 13, and the radiator 13 is fixed to a structural member of the vehicle. In the cooling module 12, the radiator 13 becomes to have high temperature than the condenser 14. For this reason, the radiator 13 is located on the rear side of the condenser 14.

The radiator 13 is a heat exchanger which cools the engine EG. Specifically, the radiator 13 exchanges heat between the engine cooling water which is cooling water circulating through the engine EG, and outside air, such that heat of the engine cooling water is radiated. The flow rate of the engine cooling water is adjusted by a water pump which is not illustrated.

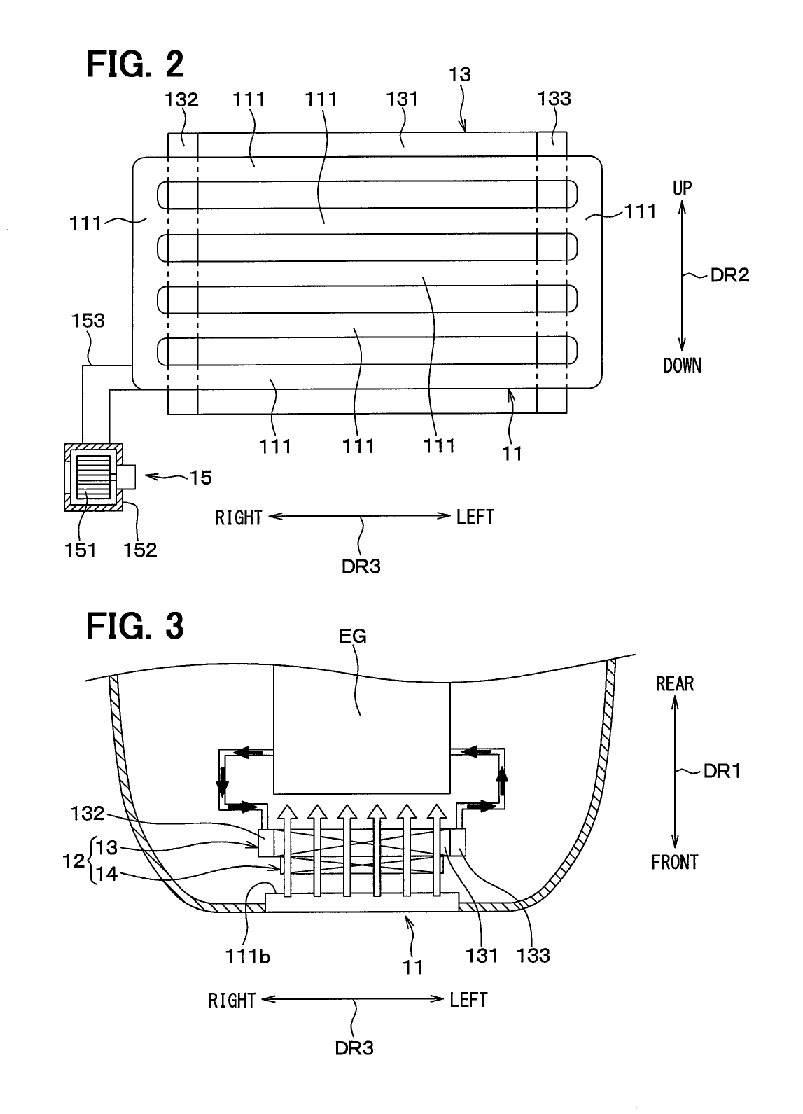

As shown in FIG. 2 and FIG. 3, the radiator 13 of this embodiment includes a heat exchange part 131 for heat exchange between the engine cooling water and the outside air, an entrance side tank part 132, and an exit side tank part 133.

The entrance side tank part 132 is a tank which supplies the engine cooling water to the heat exchange part 131. The entrance side tank part 132 of this embodiment is installed on the right side of the heat exchange part 131. In this embodiment, the entrance side tank part 132 configures an inlet part of the radiator 13 for the engine cooling water.

The exit side tank part 133 is a tank which gathers and drains refrigerant flowing out of the heat exchange part 131. The exit side tank part 133 of this embodiment is installed on the left side of the heat exchange part 131. The heat exchange part 131 of this embodiment is interposed between the entrance side tank part 132 and the exit side tank part 133 in the left and right direction DR3 of the vehicle 1. In this embodiment, the exit side tank part 133 configures an outlet part of the radiator 13 for the engine cooling water.

The condenser 14 corresponds to a radiator for a vapor-compression refrigerating cycle, which is one component of an air-conditioner which conditions air in the vehicle interior. Specifically, the condenser 14 is a radiator which radiates heat of refrigerant, by heat exchange between the refrigerant discharged out of a compressor of the refrigerating cycle, which is not illustrated, and outside air.

Next, the details of the front grille 11 of this embodiment are explained. The front grille 11 of this embodiment is located at a position opposing the heat exchange part 131 of the radiator 13. The front grille 11 of this embodiment has plural support components 111 having the hollow shape so that air can flow the inside.

Specifically, the front grille 11 of this embodiment has five support components 111 extending in the left and right direction DR3, and two support components 111 extending in the up and down direction DR2 at the both ends of the five support components 111. The support components 111 are connected with each other so that air channels 111a formed inside are communicated with each other.

As shown in FIG. 1, the support components 111 have air blow-out parts 111b to blow off the air flowing inside of the support components 111, at positions opposing the radiator 13. The air blow-out part 111b is defined by minute injection hole or slit with a thin width, which is not illustrated, so that the air flowing through the inside is blown off toward the radiator 13. The air blow-out part 111b of this embodiment is located in the entire area of the support component 111 opposing the radiator 13.

Moreover, the pump 15 which supplies air is connected to the front grille 11. The pump 15 is an electric pump for pumping air to the air channel 111a which is the interior space of the support component 111. The air channel 111a inside of the support component 111 of this embodiment functions as a duct for the air flowing from the pump 15.

The pump 15 is arranged in a position separated from the space where the wind flows when the vehicle is driven, not to become air resistance for the wind. Specifically, the pump 15 is arranged in a lower space of a front bumper FB. The pump 15 may be arranged in a space other than the lower space of the front bumper FB, at a position not to be air resistance for the wind.

The pump 15 of this embodiment includes an impeller 151, a case 152 housing the impeller 151, and a blow-out duct part 153 introducing the air from the impeller 151 to the air channel 111a of the support component 111.

The blow-out duct part 153 has an air discharge part at the downstream end that is connected to the support component 111 such that the air discharged from the impeller 151 flows into the air channel 111a of the support component 111.

If the interior space of the support component 111 is used as a duct for flowing the air from the pump 15, the air resistance may become large in the air channel 111a of the support component 111.

So, according to this embodiment, the pump 15 is configured by a centrifugal pump in which static pressure is high, compared with an axial flow pump or a mixed flow pump. That is, the pump 15 has strong power for sending air. In addition, a sirocco fan or a turbofan may be used for the impeller 151.

Next, the operation of the cooling device 10 of this embodiment is explained. In the cooling device 10 of this embodiment, in case where it is expected that a large amount of the wind is introduced into the engine room ER, for example, when the vehicle 1 is travelling with high speed, the pump 15 is not actuated, and heat is radiated from the radiator 13 by the wind generated when the vehicle is driven.

When the radiator 13 is cooled by the wind, without working the pump 15, it is necessary to suppress the air resistance so that the wind is introduced into the radiator 13 while the vehicle is driven.

On the other hand, in the cooling device 10 of this embodiment, the pump 15 is located at the position separated from the space where the wind is introduced, and the air channel 111a of the support component 111 of the front grille 11 is used as a duct for the air flowing from the pump 15.

For this reason, since a device which supplies air toward the radiator 13 does not become air resistance for the wind, the air resistance coefficient Cd can be reduced when the vehicle is travelling with high speed. As a result, since the energy loss caused by the air resistance can be suppressed, the fuel consumption of the vehicle 1 can be reduced.

In contrast, when the vehicle 1 is travelling with low speed, in the cooling device 10 of this embodiment, it is not expected that the wind is sufficiently introduced into the engine room ER. In this case, the pump 15 is actuated, and the radiator 13 radiates heat using the air flow generated by the pump 15.

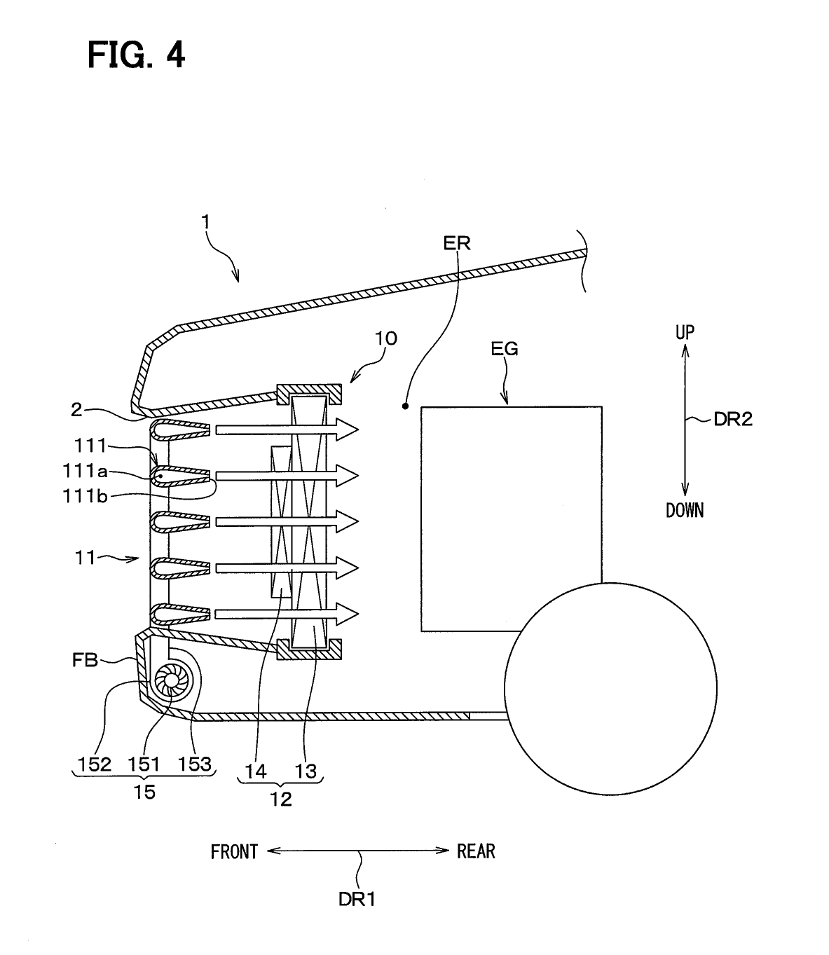

According to the cooling device 10 of this embodiment, when the pump 15 is actuated by supplying electric power, the air blown out of the pump 15 is supplied to the air channel 111a which is the interior space of the support component 111. The air supplied to the air channel 111a of the support component 111 is blown off from the air blow-out part 111b. As shown in FIG. 4, the air blown off from the air blow-out part 111b passes in order of the condenser 14 and the radiator 13, and is discharged toward the engine EG on the rear side of the vehicle.

Thus, in this embodiment, air is blown off from a part of the support component 111 of the front grille 11 which opposes the radiator 13. Accordingly, the area in which the air flows in the radiator 13 can be fully secured, compared with a case where air is blown off from a circumference of the radiator 13.

According to the cooling device 10 of this embodiment, an effective heat dissipation area in the radiator 13 can be secured, and it is possible to suppress the air resistance for the wind produced by the travelling of the vehicle 1.

Furthermore, according to the present embodiment, the centrifugal pump with high static pressure, compared with an axial flow pump or a mixed flow pump, is used as the pump 15. Accordingly, sufficient air can be supplied towards the radiator 13, in the configuration where the interior space of the support component 111 is used as a duct for the air flowing from the pump 15, like the cooling device 10 of this embodiment.

### Second Embodiment

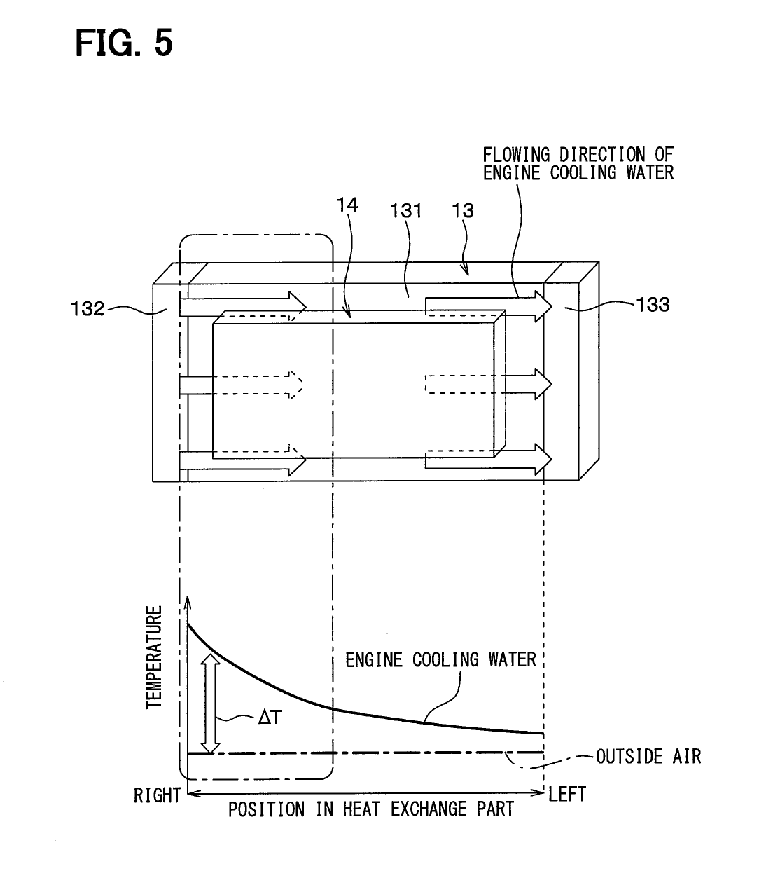

Next, a second embodiment is described with reference to FIG. 5 to FIG. 9. The present embodiment is different from the first embodiment, at a point of having set up the air blow-out parts 111b of the support components 111 in consideration of the temperature distribution of the radiator 13.

FIG. 5 illustrates a temperature distribution in the left and right direction DR3 of the heat exchange part 131 of the radiator 13. As shown in FIG. 5, the temperature of the engine cooling water in the radiator 13 becomes the highest at a location adjacent to the entrance side tank part 132 which is an inlet part for the engine cooling water, and is lowered toward the exit side tank part 133 which is an outlet part for the engine cooling water. Similarly, a temperature difference AT between the engine cooling water and the outside air becomes the largest at a location adjacent to the entrance side tank part 132, and is reduced toward the exit side tank part 133 which is an outlet part for the engine cooling water.

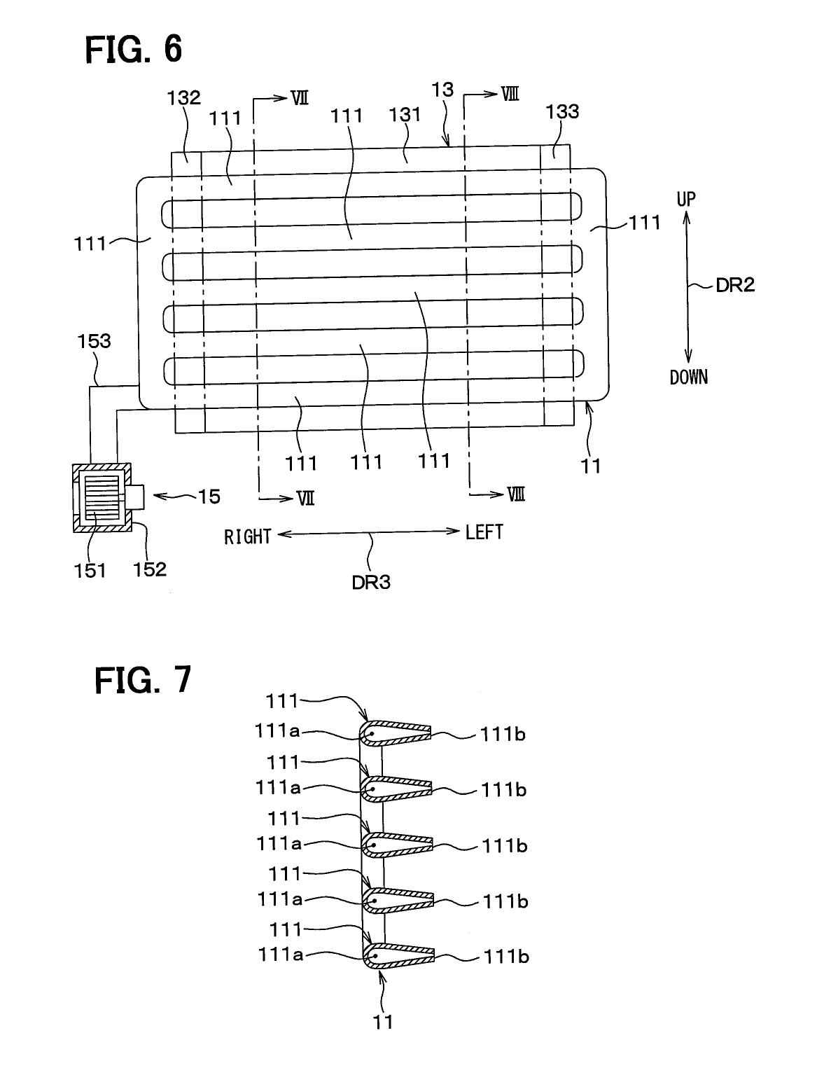

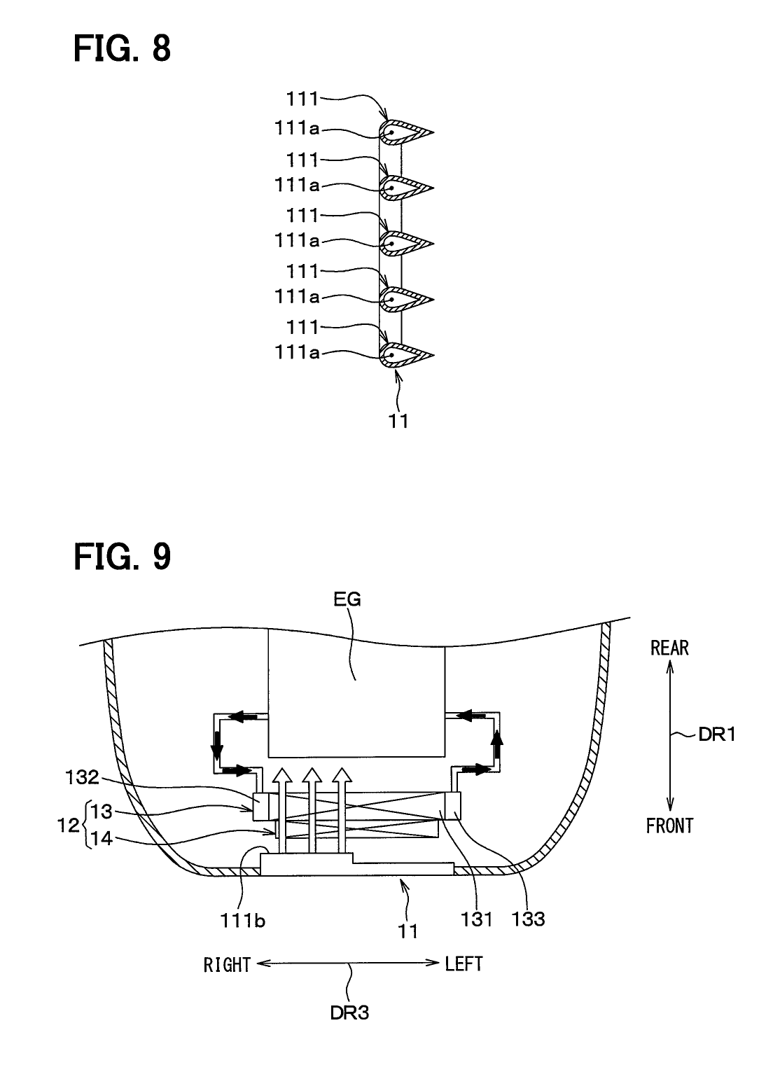

Then, as shown in FIG. 6 and FIG. 7, the front grille 11 of this embodiment has the air blow-out part 111b only at the location near the entrance side tank part 132 in the support components 111. That is, as shown in FIG. 6 and FIG. 8, the front grille 11 of this embodiment has no air blow-out part 111b at the location near the exit side tank part 133.

The other configuration is the same as that of the first embodiment. In this embodiment, since the configuration is similar to the first embodiment, the similar effect can be achieved as the first embodiment.

In particular, in this embodiment, the air blow-out part 111b is located near the entrance side tank part 132 in the support components 111. For this reason, as shown in FIG. 9, air is supplied to one side near the entrance side tank part 132 in the heat exchange part 131 of the radiator 13, by the cooling device 10 of this embodiment.

Accordingly, even if the amount of air discharged from the pump 15 is limited, a difference in temperature can be secured between the air blown off from the air blow-out part 111b and the engine cooling water in the radiator 13, to improve the heat exchange efficiency. In other words, it is possible to improve the heat exchange efficiency in the radiator 13, while the power of the pump 15 is restricted.

Here, in this embodiment, the air blow-out parts 111b of the support components 111 are located near the entrance side tank part 132, so that the air is supplied to one side near the entrance side tank part 132 in the heat exchange part 131, but is not limited to this. For example, the opening area of the air blow-out parts 111b of the support components 111 may be gradually decreased toward the exit side tank part 133 from the entrance side tank part 132.

### Third Embodiment

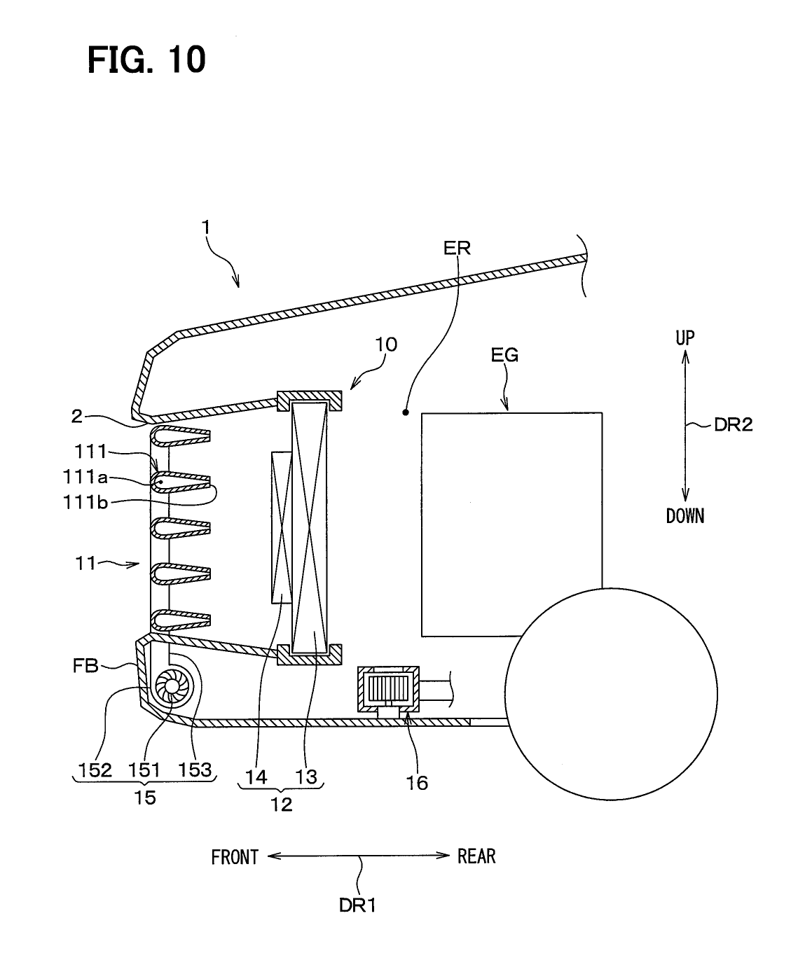

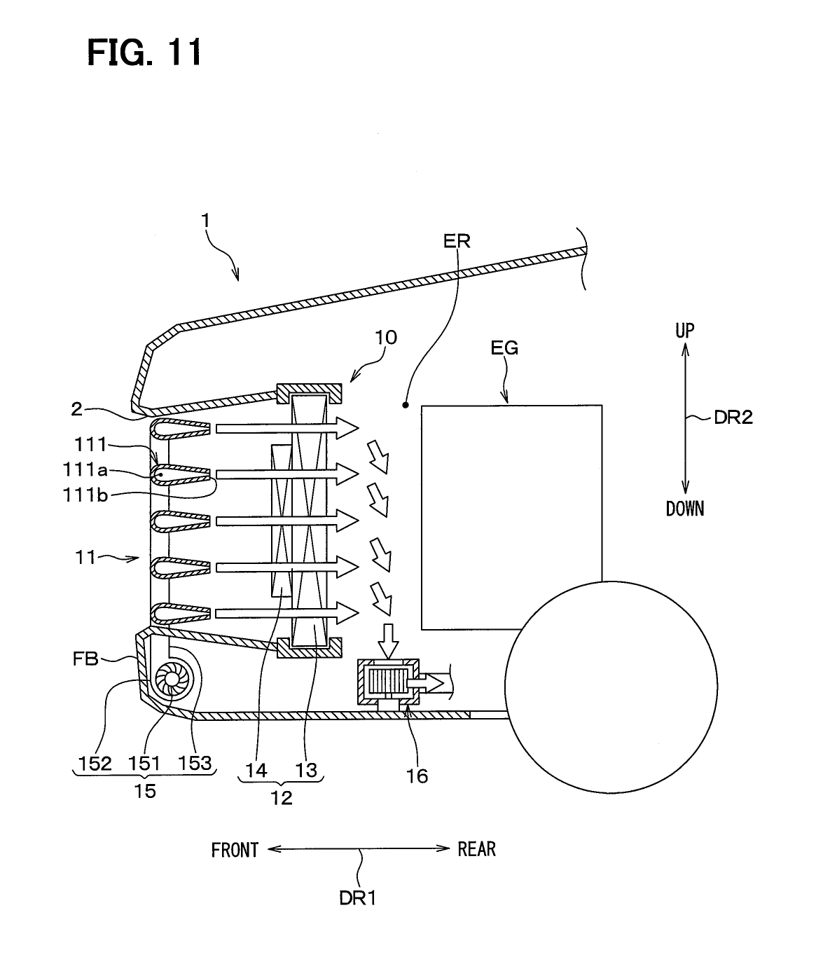

Next, a third embodiment is described with reference to FIG. 10 and FIG. 11. This embodiment is different from the first embodiment at a point of adding a fan 16 to the cooling device 10.

As shown in FIG. 10, the cooling device 10 of this embodiment further includes the fan 16 that draws air from a space between the radiator 13 and the engine EG, e.g., a space downstream of the radiator 13 in the air flow. The fan 16 of this embodiment is located near a tire of the vehicle 1, on the lower side, to discharge the drawn air to the outside. The fan 16 may be at a location other than near the tire, at a position not to be air resistance for the wind generated when the vehicle 1 is driven.

As shown in FIG. 11, when the fan 16 is actuated in the cooling device 10 of this embodiment, air is drawn from the space between the radiator 13 and the engine EG. Therefore, the pressure is lowered in the space downstream of the radiator 13 in the air flow, and a pressure difference is produced between the upstream and the downstream of the radiator 13, such that a flow of air can be produced to go from the radiator 13 toward the engine EG.

The other configuration is the same as that of the first embodiment. Since the cooling device 10 of this embodiment has a similar configuration as the first embodiment, a similar effect can be achieved as the first embodiment.

In addition, the cooling device 10 of this embodiment includes the fan 16 which draws air from the space between the radiator 13 and the engine EG. Accordingly, a flow of air which goes toward the engine EG from the radiator 13 can be generated by the pressure difference between the upstream and the downstream of the radiator 13. Since the flow rate of the air passing the heat exchange part 131 of the radiator 13 can be increased, it becomes possible to fully secure the heat dissipation capability of the radiator 13.

Moreover, like this embodiment, in the configuration where air is discharged from the space between the radiator 13 and the engine EG to the lower part of the vehicle 1, the air passing through the radiator 13 easily flows to the lower part of the vehicle 1. Therefore, it becomes possible to maintain the air resistance coefficient Cd in the vehicle 1 as small. This is effective also in the viewpoint for cooling the engine EG or other machines in the engine room ER.

### Other Embodiment

The embodiments are described to implement the present disclosure, but the present disclosure can be variously modified as follows, without being limited to the above-mentioned embodiments.

In the above-mentioned embodiments, the cooling device 10 is applied to the vehicle 1 in which the radiator 13 for radiating heat of the cooling water of the engine EG is arranged at the position where the wind is introduced when the vehicle is driven, but is not limited to this. A radiator such as the condenser 14 and an intercooler may be arranged at a position where the wind is introduced when the vehicle runs. For this reason, the cooling device 10 is applicable also to the vehicle 1 equipped with a radiator such as the condenser 14 or an intercooler.

Like the above embodiments, it is desirable to provide the air blow-out part 111b for each of the support components 111, but is not limited to this. For example, the air blow-out part 111b may be defined in at least one support component 111 of the plural support components 111.

Like the above embodiments, it is desirable to use a centrifugal pump as the pump 15, but is not limited to this. For example, the pump 15 may be an axial flow pump or a mixed flow pump.

In the above-mentioned embodiments, the entrance side tank part 132 is arranged on the right side of the heat exchange part 131, and the exit side tank part 133 is arranged on the left side of the heat exchange part 131, but is not limited to this radiator 13. For example, in the radiator 13, the entrance side tank part 132 may be arranged on the left side of the heat exchange part 131, and the exit side tank part 133 may be arranged on the right side of the heat exchange part 131. Moreover, the entrance side tank part 132 and the exit side tank part 133 may be arranged on the upper side and the lower side of the heat exchange part 131, respectively, in the radiator 13.

In the above-mentioned embodiments, of the plural support components 111 of the front grille 11, the number of the support components 111 extending in the left and right direction DR3 is larger than the number of the support components 111 extending in the up and down direction DR2, but is not limited to this.

For example, of the plural support components 111 of the front grille 11, the number of the support components 111 extending in the up and down direction DR2 may be larger than the number of the support components 111 extending in the left and right direction DR3. Moreover, the number of the support components 111 extending in the up and down direction DR2 and the number of the support components 111 extending in the left and right direction DR3 may be the same. Moreover, the support components 111 may not extend in the up and down direction DR2 or in the left and right direction DR3, and may extend in directions crossing the up and down direction DR2 or the left and right direction DR3.

In the respective embodiments above, it goes without saying that elements forming the embodiments are not necessarily essential unless specified as being essential or deemed as being apparently essential in principle.

In a case where a reference is made to the components of the respective embodiments as to numerical values, such as the number, values, amounts, and ranges, the components are not limited to the numerical values unless specified as being essential or deemed as being apparently essential in principle.

Also, in a case where a reference is made to the components of the respective embodiments above as to shapes and positional relations, the components are not limited to the shapes and the positional relations unless explicitly specified or limited to particular shapes and positional relations in principle.

### CONCLUSION

According to a first viewpoint represented by a part or all of the embodiments, the cooling device has the air blow-out part which blows off air toward the radiator at the position opposing the radiator in the support component connected to the pump.

According to a second viewpoint, the air blow-out part of the support component of the cooling device is located close to the inlet part than to the outlet part for the fluid to be cooled, at least, in the radiator.

Thus, the air blow-out part is located near the inlet part than the outlet part for the fluid to be cooled in the radiator. Accordingly, a difference in temperature can be secured between the air blown off from the air blow-out part and the fluid to be cooled in the radiator, to improve the heat exchange efficiency.

According to a third viewpoint, the cooling device includes the fan which draws air from the space downstream of the radiator in the air flow. Thus, since the fan draws air from the space downstream of the radiator in the air flow, it becomes possible to generate a flow of air which passes the radiator due to the pressure difference between the upstream and the downstream of the radiator. Thereby, the heat dissipation capability in the radiator can be fully secured, while suppressing the air resistance when the vehicle is travelling.

When the interior space of the support component of the front grille is used as a duct for the air flowing from the pump, the air resistance in the interior space of the support component may become large.

In view of this point, according to a fourth viewpoint, the pump of the cooling device is configured by the centrifugal pump. Thus, it becomes possible to sufficiently blow out the air towards the radiator by the centrifugal pump with high static pressure compared with an axial flow pump or a mixed flow pump.

What is claimed is:

1. A cooling device for a vehicle in which a radiator is disposed at a position where a wind generated when the vehicle drives is introduced, heat being exchanged between the wind and a fluid to be cooled in the radiator, the cooling device comprising:
a pump arranged to supply air and located at a position separated from a space where the wind flows; and
a front grille arranged in an introduction port where the wind is introduced, wherein
the front grille is located at a position opposing the radiator, and includes at least one support component having a hollow shape in which air is able to flow,
a discharge part of the pump is connected to the support component such that air discharged from the discharge part flows into an interior space of the support component, and
the support component has an air blow-out part at a position opposing the radiator to blow out air flowing inside of the support component.

2. The cooling device according to claim 1, wherein
the air blow-out part of the support component is located close to an inlet part of the radiator than to an outlet part of the radiator at least for the fluid to be cooled.

3. The cooling device according to claim 1, further comprising:
a fan that draws air from a space downstream of the radiator in a flow of air.

4. The cooling device according to claim 1, wherein the pump is configured by a centrifugal pump.
